(19) United States
(12) Patent Application Publication
(10) Pub. No.: US 2026/0175375 A1
(43) Pub. Date: Jun. 25, 2026

(54) A QUICK-LOCKING TOOL HOLDER ADAPTOR FOR HIGH TORQUE POWER TOOLS

(71) Applicant: OSL Cutting Technologies Limited, Sheffield, South Yorkshire (GB)

(72) Inventor: Kenneth LAX, Frecheville, Sheffield (GB)

(21) Appl. No.: 19/128,099

(22) PCT Filed: Nov. 7, 2023
(86) PCT No.: PCT/GB2023/052904

§ 371 Date: May 7, 2025

(30) Foreign Application Priority Data
Nov. 7, 2022 (GB) 2216565.8

(51) Int. Cl. B25B 23/00; B25B 21/02

(52) U.S. Cl. CPC B25B 23/0035; B25B 21/02

(57) ABSTRACT

A tool holder adaptor that is suitable for use with high torque power tools such as impact wrenches and impact drivers is provided. The adaptor includes a ball bearing based quick-action locking mechanism that is not only more resilient to withstand the forces generated by high torque power tools, but is also less vulnerable to unintentional unlocking during use.

### PRIORITY

This application claims the priority of Great Britain patent application 2216565.8, filed Nov. 7, 2022, which is hereby incorporated herein by reference in its entirety.

### FIELD

The present invention relates to adaptors for power tools and more specifically tool holder adaptors for use in connecting tool bits to high torque power tools, such as impact drivers and impact wrenches.

### BACKGROUND

Remote site work for maintenance and construction projects requires large amounts of hole cutting, hole enlarging and hole threading in order to prepare the necessary clearance for the subsequent fixing of bolts to a structure.

Typically an engineer working on a maintenance/construction project will employ one power tool, such as a magnetic drill or a combi-drill, to carry out the cutting, enlarging, and threading operations and a second power tool, such as an impact driver or impact wrench, to fix bolts into the holes prepared using the first power tool.

Although under normal circumstances the act of switching between tools during a job is only a minor inconvenience, it can become cumbersome, and sometimes even dangerous, for the engineer when they are working in locations that are not easy to access (e.g. on the underside of a bridge or on the exterior of a tall building).

It is known to employ tool adaptors, such as tool holder adaptors, to enable a single tool to be used for a wider range of operations that might otherwise be achievable.

Although tool holder adaptors have been developed to enable cutting tools (e.g. ¼ inch drill bits) to be attached to high torque power tools, such as impact drivers and impact wrenches, the high levels of torque put out by such tools can cause the tool holder adaptors and the engaged cutting tools to fail.

### SUMMARY

Provided is a quick-locking tool holder adaptor for a high torque power tool, such as an impact driver or impact wrench. In certain embodiments the adaptor comprises: a main body having a drive portion located at a first end thereof and a tool bit receiving portion located at a second opposite end thereof, wherein the drive portion is configured to operationally engage with a high torque power tool and the tool bit receiving portion is configured to receive a tool bit with a 7/16 inch hexagonal shank within a longitudinal bore; and a tool bit locking system comprising: at least one ball bearing seated within a corresponding radial bore provided in the tool bit receiving portion such that, in use, each ball bearing projects into the longitudinal bore and engages with the shank of a tool bit received therein; and a sleeve that is slidable on the outside of the tool bit receiving portion between a lock position, in which each ball bearing is prevented from retreating from the longitudinal bore, and a load position in which each ball bearing is free to retreat completely from the longitudinal bore; wherein the sleeve is urged towards the lock position by resilient biasing means; and wherein, in the load position, a portion of the sleeve extends beyond the tool bit receiving portion and the extent to which the sleeve can extend beyond the tool bit receiving portion is limited by a retaining ring, located proximal to the second end of the main body

Provided is a quick-locking tool holder adaptor for an impact wrench, said adaptor comprising: a main body having a drive portion located at a first end thereof and a tool bit receiving portion located at a second opposite end thereof, wherein the drive portion comprises a square bore configured to receive the square drive of an impact wrench and the tool bit receiving portion is configured to receive a tool bit with a 7/16 inch hexagonal shank within a longitudinal bore; and a tool bit locking system comprising: at least one ball bearing seated within a corresponding radial bore provided in the tool bit receiving portion such that, in use, each ball bearing projects into the longitudinal bore and engages with the shank of a tool bit received therein; and a sleeve that is slidable on the outside of the tool bit receiving portion between a lock position, in which each ball bearing is prevented from retreating from the longitudinal bore, and a load position in which each ball bearing is free to retreat completely from the longitudinal bore; wherein the sleeve is urged towards the lock position by resilient biasing means; and wherein, in the load position, a portion of the sleeve extends beyond the tool bit receiving portion and the extent to which the sleeve can extend beyond the tool bit receiving portion is limited by a retaining ring, located proximal to the second end of the main body.

Conventional impact driver/wrench tool holders that employ quick-locking mechanisms tend to employ a split ring to hold the components of the tool holder together. These split rings can be a point of weakness, especially given the demands of high torque power tools.

The quick-locking tool holder seeks to address this vulnerability by ensuring that the retaining ring, which is preferably a continuous ring rather than a split ring, is shielded by the sleeve at all times (i.e. both when the adaptor is in the lock position and when it is in the load position). As a result, the retaining ring is always protected against being inadvertently knocked, damaged, or dislodged, which ensures that the sleeve remains retained on the main body by the ring.

In addition, because the sleeve must be drawn away from the main body in order to unlock the tool bit locking system, the chances of the adaptor being unintentionally unlocked during use are significantly reduced.

These improvements help to provide a quick-locking tool holder adaptor with an increased robustness that makes it particularly suitable for use in connecting 7/16 inch hexagonal shank tool bits to high torque power tools (e.g. impact drivers and impact wrenches). This in turn enables an engineer to use a single power tool to carry out both hole cutting/enlarging/threads operations and bolting fixing operations.

Preferably, in the lock position, the entire sleeve may overlap with the tool bit receiving portion. In this way, when a power tool is being operated (and the adaptor is in the lock position) the sleeve is also protected from being knocked, damaged, or dislodged.

Preferably at least a portion of each ball bearing may remain within its corresponding radial bore in both the lock and load positions. By ensuring that a portion of each ball bearing is always in contact with its associated radial bore in the tool bit receiving portion, the chances of the locking system jamming when transitioning between the lock and load positions are significantly reduced.

Preferably said sleeve may comprise a pair of distinct annular rings that project radially inwards towards the main body and, in combination with the retaining ring and the tool bit receiving portion, define two enclosed annular cavities; wherein, in the lock position, the first annular ring prevents the retreat of each ball bearing and the second annular ring abuts against a projection on the drive portion to limit the extent to which the sleeve is urged down the tool bit receiving portion by the resilient biasing means; and wherein the first enclosed annular cavity houses the resilient biasing means and the second enclosed annular cavity accommodates at least a portion of each retreating ball bearing when the sleeve is in the load position.

Preferably the main body of the adaptor may be formed from chromium molybdenum steel. In this way the adaptor is better suited to withstand the forces generated during the operation of the high torque power tool.

Preferably the tool bit receiving portion of the main body may comprise a tubular structure with walls that are between 3.5-5.0 millimetres thick. This also helps the adaptor to withstand the forces generated during the operation of the high torque power tool.

Preferably the retaining ring may sit within in an annular channel provided in the outer surface of the tool bit receiving portion at a location close to the opening of the longitudinal bore. It is envisioned that sitting the retaining ring in an annular channel further reduces the possibility of the ring being dislodged, which would result in the sleeve sliding off the second end of the main body.

Alternatively or additionally the retaining ring may be positioned flush with the second end of the main body.

Alternatively or additionally the retaining ring is a continuous ring.

The adaptor is specifically intended for use with an impact wrench, as such the drive portion of the main body comprises a square bore configured to receive the square drive of an impact wrench. However it is envisaged that in an alternative embodiment an adaptor may be provided with a drive portion of the main body that comprises a ¼ inch hexagonal shank configured to be received in the ¼ inch hexagonal drive of an impact driver.

Preferably the resilient biasing means may comprise a coil spring that encircles the tool bit receiving portion of the main body.

In those embodiments where the sleeve comprises two distinct annular rings, preferably the two distinct annular rings of the sleeve each have a rectangular cross-section.

Preferably said at least one ball bearing may be formed from tungsten. It has been discovered that forming the ball bearings from tungsten further enhances the resilience of the adaptor, which is subject to increased stress and higher operating temperatures by its interaction with high torque power tools such as impact wrenches and impact drivers.

### BRIEF DESCRIPTION OF THE DRAWINGS

FIG. 1 shows a preferred embodiment of the quick-locking tool holder adaptor in accordance with embodiments of the present invention;

FIG. 2 shows the preferred embodiment of FIG. 1 from an alternative angle;

FIG. 3 shows an exploded view of the preferred embodiment of FIG. 1;

FIG. 4 shows the preferred embodiment of FIG. 1 in cross-section; and

FIG. 5 shows a preferred embodiment of the main body of a quick-locking tool holder adaptor for use with an impact driver.

### DETAILED DESCRIPTION

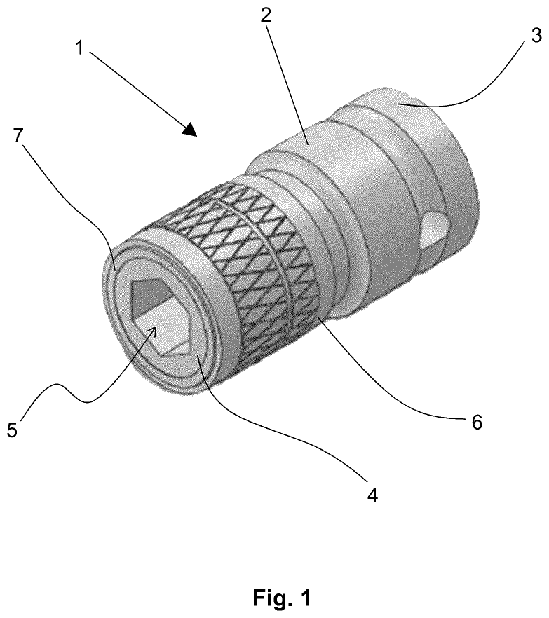

The quick-locking tool holder adaptor will now be described with reference to FIGS. 1 to 5. The robust design of the tool holder adaptor renders it particularly suited for use with high torque power tools, such as impact wrenches and impact drivers.

FIGS. 1 to 4 show an adaptor 1 that is configured to be connected to an impact wrench by receiving the square drive of the impact wrench.

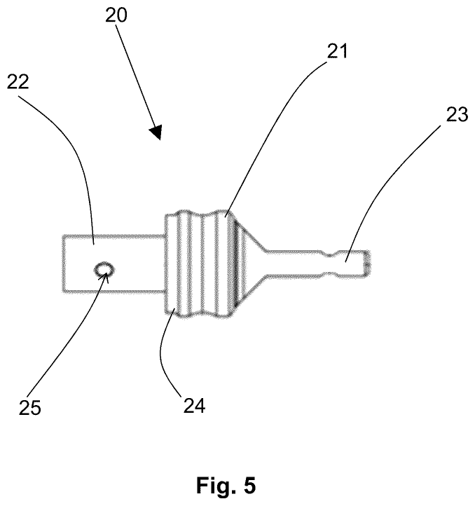

FIG. 5, on the other hand, shows the main body 20 of an adaptor that has a ¼ inch hexagonal shank that is configured to be received by the female drive of an impact driver.

It is appreciated that, with the exception of the drive portion, the majority of the adaptors'technical features (i.e. the tool bit receiving portion, the sleeve and the overall mechanism of the quick-action locking system) are conserved between an impact wrench adaptor (e.g. FIGS. 1 to 4) and an impact driver adaptor (e.g. shown in part in FIG. 5).

As such, although the complete impact driver adaptor is not shown in FIG. 5, it is appreciated that features described with reference to FIGS. 1 to 4 may also be employed in a corresponding impact driver adaptor.

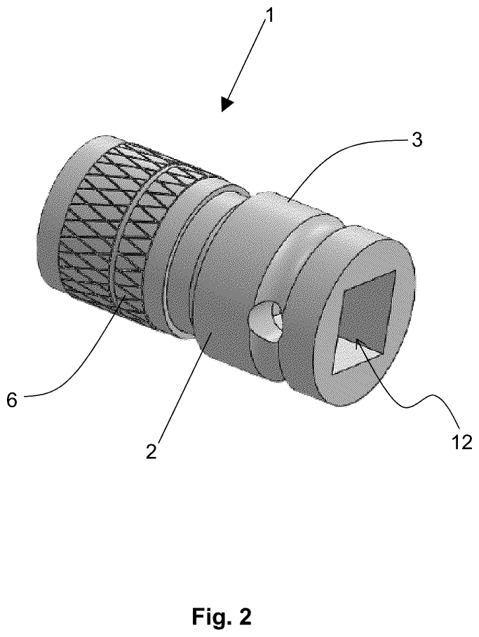

Returning now to the impact wrench adaptor 1 shown in FIGS. 1 and 2 it will be seen that the adaptor comprises a tubular shaped main body 2 formed from a suitable metal such as forged steel, and preferably chromium molybdenum steel which renders the main body 2 more resilient to the forces generated by high torque power tools.

The main body 2 comprises a drive portion 3 at a first end and a tool bit receiving portion 4 at the opposite end thereof.

The drive portion 3 is provided with a central bore 12 (see FIG. 2) that has a square cross-section which is configured to receive and engage with the standard square drive of an impact wrench.

In the adaptor 1 shown the central bore 12 is configured to receive a ½ inch square drive. However it is envisaged that in an alternative embodiment the size of the drive portion of the adaptor's main body could be increased to accommodate a central bore suitable for a ¾ inch square drive without departing from the general concept of the present invention.

The tool bit receiving portion 4 is also provided with a longitudinal bore 5 that runs along the entire length of the portion 4. The longitudinal bore 5 is configured to receive tool bits that have a 7/16 inch hexagonal shank.

It is envisioned that the longitudinal bore in alternative arrangements of the adaptor may be configured to receive other sizes and types of tool bits (i.e. non-hexagonal).

However, the choice of 7/16 inch hexagonal tool bits is considered highly preferable for tool holder adaptors that are used with high torque power tools such as impact wrenches and impact drivers. This is because the 7/16 inch size renders the tool bits more robust and less likely to snap under the high torsion forces generated by impact wrenches and impact drivers, which are much greater that the forces imparted by power tools, such as combi-drills and magnetic drills, that are typically used with cutting tool bits.

Further, in contrast to tool bits with circular shanks, tools bits with hexagonal shaped shanks are much less likely to slip within the adaptor when they are subject to the high torsion forces imparted by impact wrenches and impact drivers.

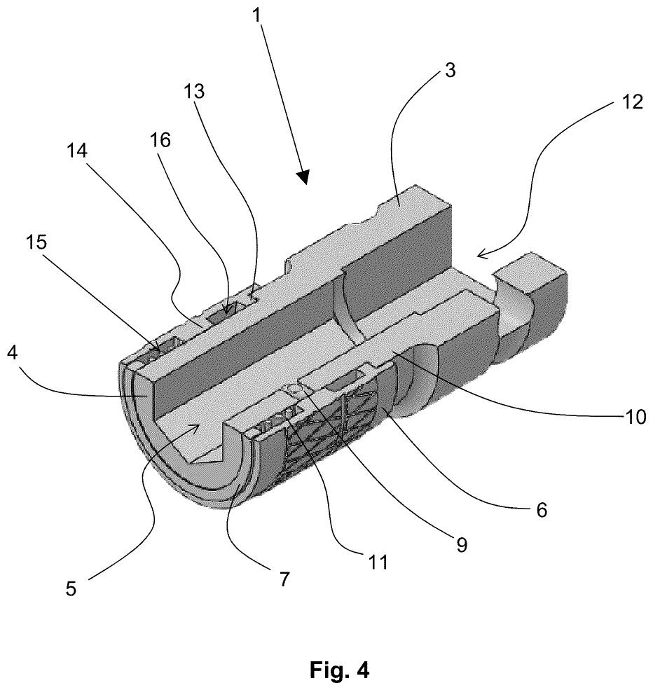

As will be appreciated from the cross-sectional view of the adaptor 1 shown in FIG. 4, the longitudinal bore 5 of the tool bit receiving portion 4 and the central bore 12 of the drive portion 3 are co-axially arranged.

In the shown embodiment the bores 5 and 12 communicate with one another to form a continuous bore that passes from one end of the main body 2 to the other end. However this is not considered essential, and it is possible that a dividing wall may be provided in some embodiments without departing from the scope of the present invention. It is appreciated that in the case of the impact driver adaptor of the present invention this is inevitable.

Preferably the transition between the longitudinal bore 5 and the central bore of the drive portion 3 is provided with some sort of stop that limits the passage of a tool bit through the adaptor. It is envisaged that the stop may be integral with the main body 2 (as is the case in the illustrated adaptor 1) or it may be provided by a separate component.

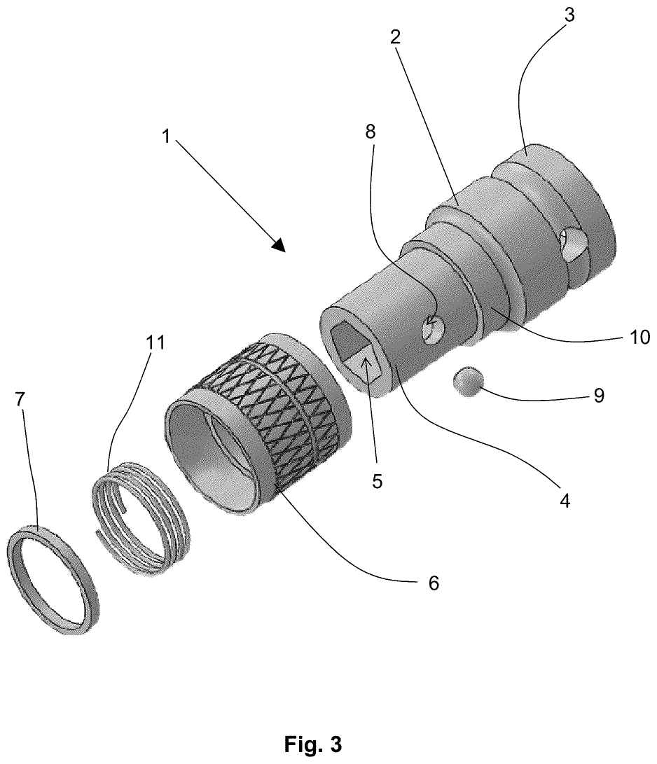

The adaptor 1 further comprises a sleeve 6, which is slidably mounted on the tool bit receiving portion 4 of the main body 2. The sleeve 6, which is retained on the main body 2 by retaining ring 7, forms part of the quick action tool bit locking system. The quick action tool bit locking system will now be described in more detail with reference to FIGS. 3 and 4, which show the internal components of the adaptor 1 more clearly.

The locking system of the adaptor employs one or more ball bearings 9 to engage with a corresponding groove in the shank of a tool bit.

Essentially, when a suitable tool bit is inserted into the longitudinal bore 5 of the tool bit receiving portion 4 of the main body 2, a portion of the ball bearing drops into the groove and, when the adaptor is in the lock position, is prevented from escaping by the sleeve 6. In this way the tool bit becomes locked in position.

The tool bit is securely retained within the longitudinal bore 5 until the adaptor is moved to the unlocked position (also referred to as the load position), at which point the ball bearing 9 is once again free to retreat from the groove in the tool bit shank and the tool bit can be retrieved from the longitudinal bore 5.

Although only one ball bearing 9 is shown in the described embodiment, it is envisaged that multiple ball bearings (e.g. preferably two, three or four) might be employed without departing from the general concept of the present invention.

The ball bearing 9, which is made of a suitable metal such as Chrome steel, sits within a radial bore 8 that extends between the outside of the tool bit receiving portion 4 and the longitudinal bore 5. Although it is envisaged that the ball bearings can be formed from steel, it is considered of particular benefit to form the ball bearings from tungsten. Tungsten ball bearings retain their shape much better than steel under the extreme operational conditions (e.g., high temperature) created during the operation of a high torque power tool such as an impact wrench or impact driver.

The majority of the radial bore 8 has a diameter that is slightly larger than the diameter of the ball bearing 9. However the aperture of the radial bore that faces into the longitudinal bore 5 necessarily has a diameter that is slightly smaller than the diameter of the ball bearing 9. The change in diameter may be abrupt or it may be tapered.

This arrangement ensures that, whilst the ball bearing 9 is free to move up and down within the radial bore 8, the ball bearing 9 is prevented from completely entering the longitudinal bore 5 by the smaller diameter of the aperture.

It will be appreciated that, although the diameter of the aperture of the radial bore 8 that faces outward towards the sleeve may allow the ball bearing to pass through it, the presence of the sleeve 6 ensures that the ball bearing cannot complete leave the adaptor.

The interaction between the sleeve 6, the main body 2 and the ball bearing 9 will now be explained in more detail with reference to FIGS. 3 and 4.

The cross-section view of FIG. 4 shows the adaptor 1 in the lock position. In the lock position the sleeve 6 overlaps entirely with the tool bit receiving portion 4 of the main body 2.

The sleeve 6, which is preferably formed from heat-treated mild steel, is provided with two internally facing annular projections 13 and 14 that extend radially inwards towards the tool bit receiving portion 4. Preferably the annular projections are integral with the rest of the sleeve 6 and have rectangular cross-sections.

The internal diameter of both annular projections 13, 14 ensures that the sleeve is free to slide relative to the tool bit receiving portion 4 of the main body 2. The extent to which the sleeve 6 can slide along the main body 2 is delimited to achieve a lock position, in which the sleeve fully overlaps with the tool bit receiving portion 4 of the main body 2, and a load position, in which the sleeve extends beyond the main body but cannot be entirely slide off the tool bit receiving portion 4 of the main body 2.

When the adaptor 1 is in the lock position, as is the case in FIGS. 1 to 4, the passage of the sleeve along the outside of the main body is stopped by the first annular projection 13 abutting against a stop, which takes the form of a lip 10 on the outside of the main body 2. This arrangement thereby keeps the adaptor in one piece.

When the adaptor 1 is in the load position, the front end of the sleeve 6 extends beyond the main body 2. However the extent to which the sleeve can move along the main body 2 is controlled by the interaction between the second annular projection 14 and the retaining ring 7. This ensures that the sleeve cannot be completely removed from the main body 2.

Resilient biasing means, in the form of a coil spring 11, is provided within an annular cavity 15 that is defined by the retaining ring 7 and the second annular projection 14 of the sleeve 6. The coil spring 11 is configured to urge the retaining ring 7 and the second annular projection 14 apart, which in turn urges the sleeve towards the lock position shown.

It will therefore be appreciated that the default position for the adaptor is the lock position. In order to place the adaptor 1 in the load position (i.e. so that a tool bit can be received) a user must first pull the sleeve 6 forwards away from the main body 2. Once the tool bit has been inserted that sleeve 6 can be allowed to snap back into the lock position.

The requirement that the sleeve 6 must be pulled away from the main body 2 to load a tool bit means that the sleeve cannot be accidentally unlocked during use by knocking the sleeve against the work piece. This provides a clear safety benefit.

In the embodiment shown in FIGS. 1 and 2 the retaining ring, which is a continuous ring that is preferably made from chromium molybdenum steel, is retained on the outside of the main body 2 by way of an interference fit. However, it is envisaged that in alternative embodiments the retaining ring may be seated within an annular channel in the main body 2 to further help retain its position and that of the sleeve 6.

It is appreciated that by using a continuous ring, rather than a split ring, for the retaining ring the adaptor 1 is rendered more resilient. With that said, because the retaining ring is always shielded by the sleeve, the use of a continuous ring, although advantageous, is not considered essential.

The first and second annular projections of the sleeve define an annular cavity 16 that is configured to accommodate the ball bearing 9 when it retreats away from the longitudinal bore 5 within the radial bore 8.

The depth of the annular cavity 16 is such that, although the ball bearing can retreat entirely from the longitudinal bore 5, only a portion of the retreating ball bearing can be accommodated therein. The rest of the ball bearing 9 is retained within its corresponding radial bore 8. As the ball bearing 9 never completely leaves the radial bore there is no need for a ramped runway for the ball bearing to run on to avoid instances of jamming. This means that the sleeve's second annular projection 14 can have a simple rectangular cross-section, which simplifies the manufacture of the sleeve.

As can be appreciated from FIG. 4, when the adaptor 1 is in the lock position the second annular projection 14 is aligned with the ball bearing 9 such that it is prevented from retreating from the longitudinal bore 5. As noted above, the sleeve 6 is retained in this position as the default by virtue of the coil spring 11 held within the annular cavity 15 between the second annular projection 14 and the retaining ring 7.

It is envisaged that the strength of the spring can be selected according to the level of resistance required during the transition between the lock position and the load position.

When the sleeve 6 is pulled forward by a user into the load position, the second annular projection 14 moves out of alignment with the ball bearing 9 and the annular cavity 16 is instead brought into alignment with the ball bearing 9. At this point, the ball bearing is free to retreat completely from the longitudinal bore 5 but only partially into the cavity 16.

It will be appreciated that the act of pulling a tool bit from the adaptor when it is in the load position will push the ball bearing out of the longitudinal bore 5 towards the annular cavity 15. Similarly, when a tool bit is inserted into an adaptor that is in the load position, the tool bit will push the ball bearing out of the way as it enters the longitudinal bore 5 of the tool bit receiving portion.

In a second preferred embodiment there is provided an impact driver adaptor. As the arrangement of the quick action locking mechanism is essentially the same for both embodiments of the adaptor, FIG. 5 only shows the main body 20 of a preferred embodiment of an impact driver adaptor.

The main body 20, which is preferably formed from chromium molybdenum steel, comprises a drive portion 21 located at one end thereof and a tool bit receiving portion 22 located at the other end thereof.

Although not shown in FIG. 5, it will be appreciated that, once again, the tool bit receiving portion is provided with a longitudinal bore that is configured to receive the hexagonal shank of a 7/16 inch tool bit.

In contrast to the drive portion 3 of the impact wrench adaptor shown in FIGS. 1 to 4, the drive portion 21 shown in FIG. 5 comprises a ¼ inch hexagonal shank which, in use, is received by the female drive of an impact driver.

As noted above, although the sleeve, ball bearing and retaining ring components of the adaptor are not shown in FIG. 5, it will be appreciated that they interact with the tool bit receiving portion 22 in a way that is similar to how they do with the tool bit receiving portion 4 of the adaptor shown in FIGS. 1 to 4.

In this regard, it will be appreciated that the drive portion 21 is provided with a lip 24 that delimits the sliding movement of the sleeve (not shown) along the main body in a similar manner to that described above with respect to the first preferred embodiment.

Further, the tool bit receiving portion 22 is also provided with a radial bore 25 that accommodates the ball bearing of the quick action locking mechanism in the same manner as has already been described.

This locking system allows a user to quickly and intentionally engage and disengage a tool bit and the adaptor 1, which in turn is secured to the drive of an impact wrench or impact driver. Further, the adaptor and the tool bit can be removed from the power tool and replaced with a more traditional high torque tool head, such as a bolt fixer.

In this way the quick-locking tool holder adaptor enables a user to use a single high torque power tool (e.g. an impact wrench/impact driver) to carry out both traditional operations, such as bolt fixing, and operations, such as cutting holes, that would normally be carried out using a separate power tool (e.g. combi-drill, magnetic drill).

The following clauses are various non-limiting example aspects of the present invention:
1. A quick-locking tool holder adaptor for a high torque power tool such as an impact driver or impact wrench, said adaptor comprising:
   a main body having a drive portion located at a first end thereof and a tool bit receiving portion located at a second opposite end thereof, wherein the drive portion is configured to operationally engage with a high torque power tool and the tool bit receiving portion is configured to receive a tool bit with a 7/16 inch hexagonal shank within a longitudinal bore; and
   a tool bit locking system comprising:
      at least one ball bearing seated within a corresponding radial bore provided in the tool bit receiving portion such that, in use, each ball bearing projects into the longitudinal bore and engages with the shank of a tool bit received therein; and
      a sleeve that is slidable on the outside of the tool bit receiving portion between a lock position, in which each ball bearing is prevented from retreating from the longitudinal bore, and a load position in which each ball bearing is free to retreat completely from the longitudinal bore;
   wherein the sleeve is urged towards the lock position by resilient biasing means; and
   wherein, in the load position, a portion of the sleeve extends beyond the tool bit receiving portion and the extent to which the sleeve can extend beyond the tool bit receiving portion is limited by a retaining ring, located proximal to the second end of the main body.
2. The adaptor of clause 1, wherein in the lock position the entire sleeve overlaps with the tool bit receiving portion.
3. The adaptor of clause 1 or 2, wherein at least a portion of each ball bearing remains within its corresponding radial bore in both the lock and load positions.
4. The adaptor of clause 1, 2 or 3, wherein said sleeve comprises a pair of distinct annular rings that project radially inwards towards the main body and, in combination with the retaining ring and the tool bit receiving portion, define two enclosed annular cavities;
   wherein, in the lock position, the first annular ring prevents the retreat of each ball bearing and the second annular ring abuts against a projection on the drive portion to limit the extent to which the sleeve is urged down the tool bit receiving portion by the resilient biasing means; and
   wherein the first enclosed annular cavity houses the resilient biasing means and the second enclosed annular cavity accommodates at least a portion of each retreating ball bearing when the sleeve is in the load position.
5. The adaptor of any one of clauses 1 to 4, wherein the main body is formed from chromium molybdenum steel.
6. The adaptor of any one of clauses 1 to 5, wherein the tool bit receiving portion of the main body comprises a tubular structure with walls that are between 3.5-5.0 mm thick.
7. The adaptor of any one of the preceding clauses, wherein the retaining ring sits within an annular channel provided in the outer surface of the tool bit receiving portion at a location close to the opening of the longitudinal bore.
8. The adaptor of any one of the preceding clauses, wherein the drive portion of the main body comprises a square bore configured to receive the square drive of an impact wrench.
9. The adaptor of any one of clauses 1 to 7, wherein the drive portion of the main body comprises a ¼ inch hexagonal shaft configured to be received in the ¼ inch hexagonal drive of an impact driver.
10. The adaptor of any of the preceding clauses, wherein the resilient biasing means comprise a coil spring that encircles the tool bit receiving portion of the main body.
11. The adaptor of any of clauses 4 to 10, wherein the two distinct annular rings of the sleeve each have a rectangular cross-section.

1-9. (canceled)

10. A quick-locking tool holder adaptor for an impact wrench, the adaptor comprising:
a main body having a drive portion located at a first end thereof and a tool bit receiving portion located at a second opposite end thereof, wherein the drive portion comprises a square bore configured to receive a square drive of an impact wrench, and the tool bit receiving portion is configured to receive a tool bit with a 7/16 inch hexagonal shank within a longitudinal bore; and
a tool bit locking system, comprising:
at least one ball bearing seated within a corresponding radial bore provided in the tool bit receiving portion such that, in use, each ball bearing projects into the longitudinal bore and engages with the shank of a tool bit received therein; and
a sleeve that is slidable on the outside of the tool bit receiving portion between a lock position, in which each ball bearing is prevented from retreating from the longitudinal bore, and a load position in which each ball bearing is free to retreat completely from the longitudinal bore;
wherein the sleeve is urged towards the lock position by resilient biasing means; and
wherein, in the load position, a portion of the sleeve extends beyond the tool bit receiving portion and the extent to which the sleeve can extend beyond the tool bit receiving portion is limited by a retaining ring, located proximal to the second end of the main body.

11. The adaptor of claim 10, wherein in the lock position the entire sleeve overlaps with the tool bit receiving portion.

12. The adaptor of claim 10, wherein at least a portion of each ball bearing remains within its corresponding radial bore in both the lock and the load positions.

13. The adaptor of claim 10, wherein said sleeve comprises a pair of distinct annular rings that project radially inwards towards the main body and, in combination with the retaining ring and the tool bit receiving portion, define two enclosed annular cavities;
wherein, in the lock position, the first annular ring prevents the retreat of each ball bearing and the second annular ring abuts against a projection on the drive portion to limit the extent to which the sleeve is urged down the tool bit receiving portion by the resilient biasing means; and
wherein the first enclosed annular cavity houses the resilient biasing means and the second enclosed annular cavity accommodates at least a portion of each retreating ball bearing when the sleeve is in the load position.

14. The adaptor of claim 13, wherein the two distinct annular rings of the sleeve each have a rectangular cross-section.

15. The adaptor of claim 10, wherein the main body is formed from chromium molybdenum steel.

16. The adaptor of claim 10, wherein the tool bit receiving portion of the main body comprises a tubular structure with walls that are in a range of 3.5 mm to 5.0 mm thick.

17. The adaptor of claim 10, wherein the retaining ring sits within an annular channel provided in the outer surface of the tool bit receiving portion at a location close to the opening of the longitudinal bore.

18. The adaptor of claim 10, wherein the resilient biasing means comprises a coil spring that encircles the tool bit receiving portion of the main body.
